(19) United States
(12) Patent Application Publication
(10) Pub. No.: US 2005/0081793 A1
(43) Pub. Date: Apr. 21, 2005

(54) Container for urine

(76) Inventor: Martti Johannes Sannikka, Artarmon (AU)

Correspondence Address: MICHAEL MOLINS;MOLINS & CO., SUITE S, LEVEL 6, 139 MACQUARIE ST, SYDNEY NSW, 2000, AU

(21) Appl. No.: 10/685,598

(22) Filed: Oct. 16, 2003

(51) Int. Cl. A01K 1/035

(52) U.S. Cl. 119/165

(57) ABSTRACT

Disclosed is a disposable plastic container, used to collect and test veterinary and medical urine samples from cats, dogs and people. A commercial urine test strip is attached on the outside of the container inside a protective envelope. Once opened, the strip is dipped into the urine and a chemical reaction changes the color of the pads. This color is then compared to a reference color on the label which may also be attached to the container. For cats the containers may be loaded with litter and placed inside a multi compartment partitioned litter box.

### FIELD OF THE INVENTION

The invention pertains to containers, particularly disposable plastic containers for the veterinary and medical collection and testing of urine using commercially available medical urine test strips.

### BACKGROUND OF THE INVENTION

The content of the Applicant's prior application 10/443055, Partitioned Cat Litter Box, is incorporated herein by reference. Urine is collected for several reasons including legal, medical, bacteriological and biochemical testing. The most cost-effective devices used to perform the non-invasive macroscopic portion of urinalysis are commercially prepared medical test strips. These narrow plastic test strips hold test pads that have chemicals in them. When dipped briefly into urine, these pads absorb the urine and a chemical reaction changes the color of the pads. It allows qualitative and semi quantitative determination at least ten different parameters by comparison between the reaction colors on the test strip and the reference colors on the label. The same strips can be used for people and their pets i.e. cats and dogs. It is ironic, that despite the test strips being aimed for professional use, people at home can use the same strips easily as the urologists at registered laboratories, for a simple and fast indication of illness or infection in urinary tract, bladder, kidneys, liver etc.

The most frequently performed chemical tests using reagent test strips include: Specific gravity, pH, protein, glucose, ketones, blood, leukocyte esterase, nitrite, bilirubin and urobilinogen. However, there are more than 100 different tests that can be performed on urine.

Urine sample is normally obtained by one of the following three methods: catheterization by inserting a flexible plastic tube through the urethra into the bladder, cystocentesis by introducing a needle directly into the bladder through the body wall or clean-catch midstream sampling ie. urinating into a clean container. The clean-catch method is by far the most popular but it is the least sterile and is associated with the most lab errors and repeat tests.

This invention pertains in part, to the clean-catch method. The corresponding prior art is replete with examples of devices for cats using various litter boxes and litters, dogs using, metal ladles, small plastic bottles and specially adapted urine collectors for women including systems requiring body contact. Several systems intended for women are in practice too messy, unhygienic and inconvenient to use, as it is difficult to place and hold any testing container in the midstream without splashing, contaminating hands, garments and the whole area causing embarrassment and distress.

The invention can be used by the whole family including males, females and two of the most popular pets i.e. cats and dogs. The urine sample can be collected and tested in the original disposable inexpensive plastic container eliminating the need to handle and transfer the urine. Thus it would be advantageous to have a self-contained system allowing low cost health checks to be performed particularly at home when any of the members appears to be sick without obvious cause. The proposed invention addresses at least some of the above concerns.

### OBJECTS AND SUMMARY OF THE INVENTION

It is a general object of the invention to provide an inexpensive disposable polymeric container suitable for collection of urine sample from four distinctly separate groups namely cats, dogs, men and women and testing the urine most often at home using an individually sealed commercially available test strip attached to each container.

When used for cats the object of the invention is to provide a container, which facilitates the proper utilization of urine test strips or color changing reagent powders adapted to be used with various litters suitable for collection and testing of veterinary urine samples with the aid of a multi compartment cat litter box of the type disclosed in the applicant's co pending U.S. application, Ser. No. 10/443,055 titled ‘Partitioned Cat Litter Box’.

When used for dogs an object of the invention is to provide a container, which facilitates collection of veterinary urine samples with or without an optional improvised extension handle where a second identical container is used as a cradle where the test container could be nested during the collection, most often during the morning walk.

With regard to women an object of the invention is to provide a container, which is dimensioned to be housed in the bottom of the ordinary toilet bowl above the water level so that a woman while comfortably seated can collect a midstream urine sample simply by leaning forward during the mid part of the uninterrupted voiding process without the need to hold the container. Men can hold the container manually.

### BRIEF DESCRIPTION OF THE DRAWING FIGURES

FIG. 1 is a perspective view of the container.

FIG. 2 is a top view of the container.

FIG. 3 is a cross section of the container taken along line 3-3 of FIG. 2 showing the locations of the protective envelope containing a urine test strip, its reference color label and optional cat litter.

FIG. 4 is a cross section of the container taken along line 4-4 of FIG. 2.

FIG. 5 is an illustration of containers in a nested formation.

FIG. 6 is a top plan view of the disposable snap-on lid.

FIG. 7 is a cross section of the lid taken along line 7-7 of FIG. 6.

FIG. 8 is a top plan view of the envelope containing the test strip.

FIG. 9 is a top plan view of the test strip.

FIG. 10 is a plan view of the label showing various reference color ranges and legend for items covered by the test strip.

FIG. 11 is a perspective view showing how the containers are loaded and used in a cat litter box.

FIG. 12 is a cross section of the litter box taken along line 12-12 of FIG. 11 showing the open maintenance position and how the containers are accessed for removal, reloading and closing of lids.

FIG. 13 is a cross section of the container when applied to dogs using an optional improvised handle.

FIG. 14 is an illustration how ladies can collect the clean-catch midstream urine sample into the container while leaning forward during the mid part of the uninterrupted urination process while seated on the normal toilet bowl.

### BEST MODE AND OTHER EMBODIMENTS OF THE INVENTION

The container could be described as an inexpensive, disposable, convenient container similar to the ones used for dairy or deli foods at a retail store. As it has no microwave, freezer or dishwasher use, it can be made thin walled using APET (amorphous polyethylene terephthalate) or PP (polypropylene). As the lids do not require the see-through clarity they could be made of HDPE (high density polyethylene), which is readily recyclable. An injection molding or thermoforming process could manufacture both parts.

The container's general shape is: rectangular for storage space utilization, tapering to simplify molding, stackable to save volume, lidded to stop spillage, thin walled to minimize material costs, raised mounded to stiffen the bottom and reduce splashing and when used for cats with small amounts of litter for waste disposal to allow quick draining of urine into the bottom grooves where the litter can absorb it more efficiently, disposable to eliminate cleaning, wide mouthed to catch urine efficiently, large enough to accommodate a hand holding a test strip without touching container walls, dimensioned to rest in the toilet bowl without its bottom touching the water and without its mouth touching the bowl walls so that unwanted urine flow along the bowl walls bypasses the container.

The container's approximate dimensions could be: height 50 mm, width 120 mm, length 175 mm, volume 650 ml, wall thickness 0.2 mm and the height of the two centrally located bottom mounds 10-15 mm. The container may be provided empty or charged with a portion of cat litter of any kind, with or without lid.

The clean-catch midstream sample should be captured with a sterile disposable container and the testing should be performed while the sample is fresh. A reasonable upper time limit for testing is 2 hours from voiding (4 hours with refrigerated samples). The sample should be thoroughly shaken in the container prior to testing. The test strip should be only briefly (about 1 second) dipped into the urine making sure that all the test pads are moistened. After a specified time (typically 1 minute) the reaction colors on the test strip should be compared with the reference colors on the label attached on the outside wall of the container while holding the strip in a horizontal position. The results should be noted for later use during consultation with the professionals. Any color changes appearing only along the edges of the test pads, or developing after more than two minutes, do not have any diagnostic significance. The sample can be transported to a medical facility for professional examination while in the original container or for more complicated traveling arrangements, the urine sample could be poured into a special screw-capped container that can be packed in a transport box with ice packs.

Diagnosis or therapy should never be based on one test result alone but should be established in the context of all other medical findings. This invention should be used under the directions of veterinarians or doctors when their clients are worried that their pets, or the people themselves are sick without apparent cause. The home test may give false positive results for various reasons, but it may also reveal unnoticed diseases and give preliminary guidance before the consultation, professional sampling and prognosis.

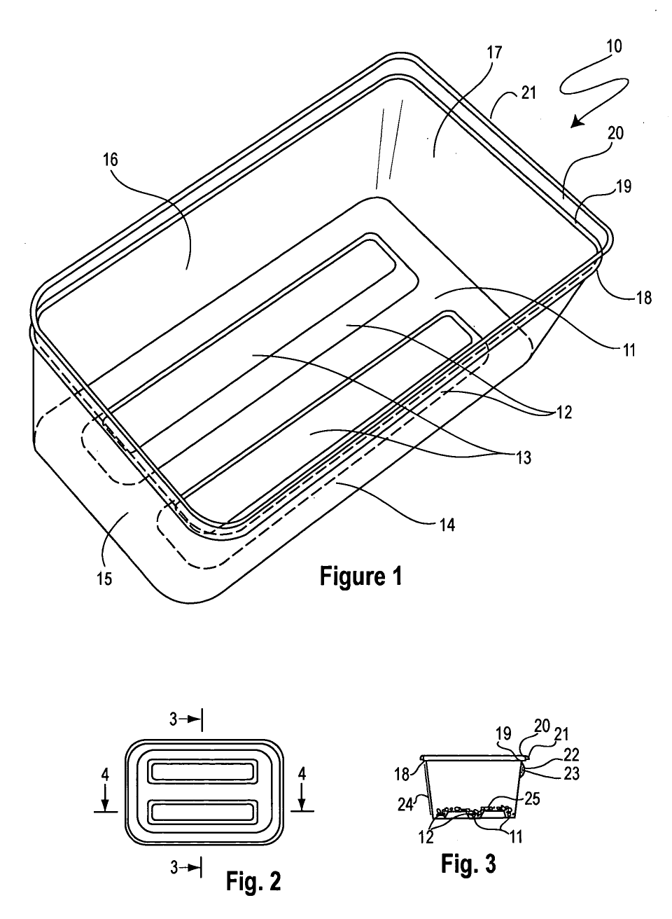

FIG. 1 is a perspective view of container 10. It has rectangular bottom 11 including a pair of tapering raised mounds 12 with flat, horizontal tops 13. Sidewalls 14, 15, 16 and 17 extend upwardly and slightly outwardly from the periphery of the bottom surface. The sidewalls are terminated with an outwardly and horizontally extending peripheral de-nesting shoulder 18 having a surface 19 merging with the vertical surface of mouth 20 and downwardly curving upper lip 21. Surfaces 19 and 20 seal and mate with snap-on lid surfaces 27 and 28 shown in FIG. 7. Optional shoulders 18 locate the containers when stacked in a nested formation as shown in FIG. 5. Raised mounds 12 serve (in part) to stiffen the thin walled construction of the container bottom and reduce splashing of urine. Downward peripheral lip 21 strengthens the mouth of the container and safely terminates the otherwise upwardly pointing thin and sharp edges of the sidewalls.

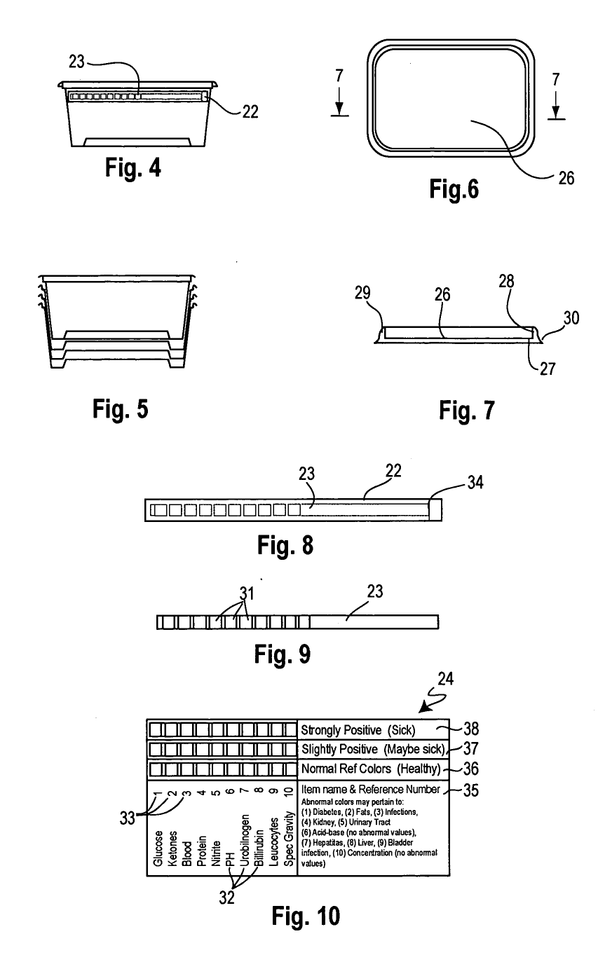

FIG. 2 is a top view of the container 10 showing section lines for FIGS. 3 and 4.

FIG. 3 is a cross section of the container taken along line 3-3 of FIG. 2. It shows bottom 11, raised mounds 12, de-nesting shoulder 18, surfaces 19 and 20, which seal with the lid, downwardly curving upper lip 21, and the locations of protective sealed envelope 22 containing urine test strip 23, its reference color label 24 and optional cat litter 25.

FIG. 4 is a cross section of the container taken along line 4-4 of FIG. 2 showing basically the same items as FIG. 3 from a different angle. Note location of protective envelope 22 containing test strip 23. The thin envelope is located on an exterior surface of the container. The envelope 22 is readily removed, for example by attachment using a weak adhesive, so that it can be opened. In the alternative the envelope is permanently attached, but easily opened so that the strip 23 can be removed.

FIG. 5 shows a few stacked containers 10 in a nested formation. There is sufficient room inside a lower container, relative to an upper and adjacent one, for the slim lined envelope (not shown in this Figure) containing the single test strip and its reference color label attached on the outside of the opposite sidewall to be nested in the upper container for transport and storage. The lids (not shown in this Figure) can be stacked the same way as the containers or a single container with the lid snapped on can be sold individually packaged.

FIG. 6 is a top plan view of the polymeric thin walled disposable snap-on lid 26. The lids are not always required, but when used, they stiffen the closed container and stop its contents from spilling. They also help to maintain the integrity of the sample i.e. stop carbon dioxide from escaping and changing pH. Closing the lid makes the whole parcel sanitary from inside.

FIG. 7 is a cross section of lid 26 taken along line 7-7 of FIG. 6. When closed, the outside horizontal edge of lid's bottom surface 27 will rest on container shoulder's horizontal surface 19 supporting the lid. Peripheral wall 28 of the lid having slightly larger diameter than container mouth 20 forms the main leak resistant seal between these two vertical surfaces. Inverted peripheral channel 29 with rounded top and substantially vertical parallel walls will house the downwardly curving lip 21 of the container. Outwardly curving peripheral skirt 30 will help to locate the lid on the container while being snapped on and help to remove the lid when the container is being opened.

FIG. 8 is a top plan view of a non-transparent plastic envelope 22 hermetically sealing inside it, a test strip 23. The envelope protects the strip from air and contamination until the envelope is torn or cut open along line 34 or otherwise and the strip pulled out and used. The envelope may be clear or optionally opaque, at least to selected damaging frequencies of light. The commercially available test strips come normally in boxes containing 100 strips. It is hard to maintain the integrity of all of those perishable test pads (the ketones are first to perish) while the box is opened 100 times for removal of each strip. Some test pads may become discolored before the use-by date due to moisture or exposure to light or handling and incorrect results may be obtained. That is why this invention uses a single medical urine test strip, sealed until required before the use-by date inside an individual small envelope attached to the outside wall of each container. FIG. 9 is a top plan view of the narrow plastic test strip 23 with several chemically treated color changing test pads 31 formed on it. The most common pads include specific gravity, pH, protein, glucose, ketones, blood, leukocyte esterase, nitrite, bilirubin and urobilinogen. Various combinations having 3, 6 or 10 parameters are common with typically 5 color steps for each parameter. Some test strips have only one parameter displayed with narrowly incremented color pads. For example, test strip showing pH alone can be used for monitoring of various diets or glucose only test strip could be used for health monitoring of diabetic pets as taking blood samples at home by the caregivers is out of the question. Different type test strips can be packaged individually for various needs.

FIG. 10 suggests use of simplified label 24 where each parameter item has medical name 32 and reference number 33 with legend 35 guiding to area where the possible problems could be. The label has color range charts 36, 37 and 38 against which the test strip is compared. The label colors could be simplified to three ranges: normal, slightly positive and strongly positive. If all the pads on the test strip display the same set of colors as the ‘Normal Reference Colors’ the individual is likely to be ‘Healthy’ in reference to the tested items. If any of the test strip colors indicate ‘positive’ response there might be a medical problem providing that the test strips have been used correctly. It requires experience and careful observations otherwise misreading or misinterpreting may result in wrong determinations. With any positive result, professional guidance is needed.

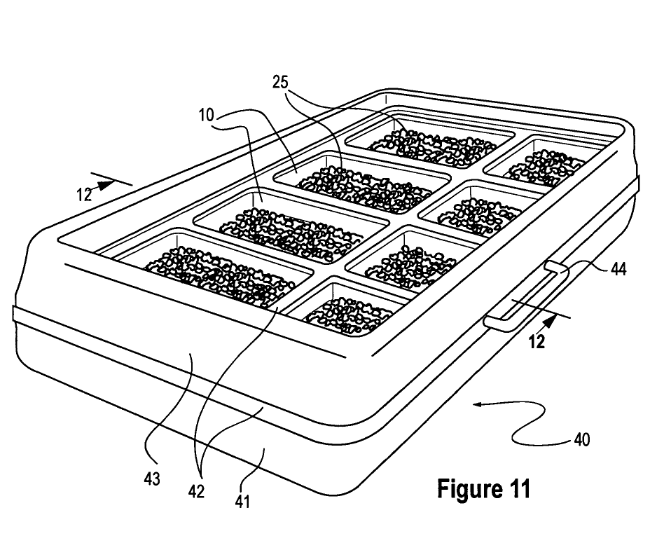

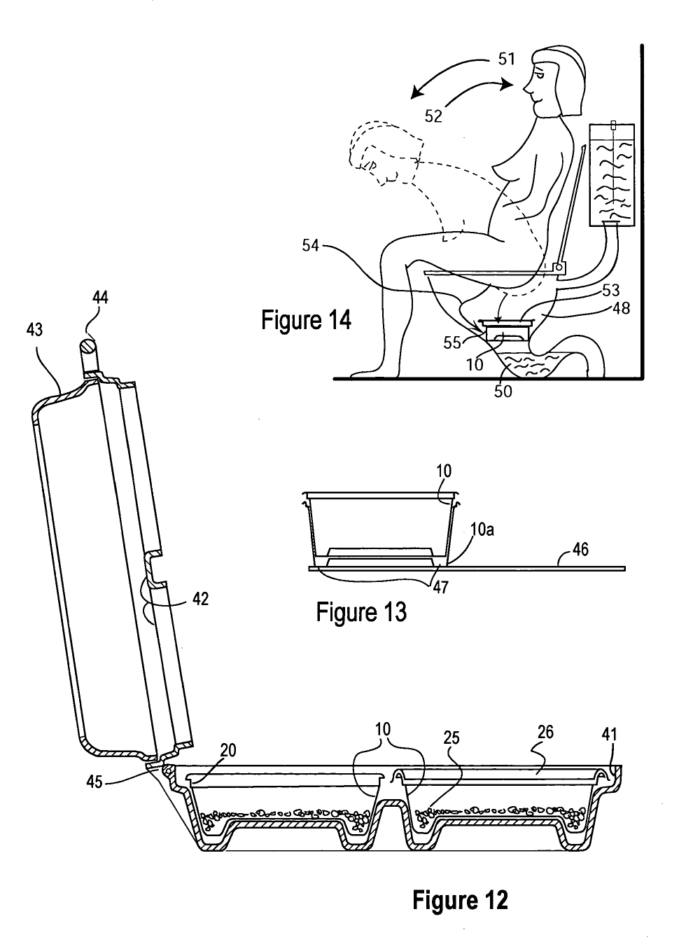

FIGS. 11 and 12 show how the containers 10 are used for cats, using clean unused disposable containers with test strips attached. As cats are fussy and due to their independent toilet habits, both veterenary and non-vetenerary needs may require a particular litter type and different approaches. These needs are facilitated by using a multi compartment kitty litter box 40 of the kind depicted in the applicant's co pending United States patent application. FIG. 12 shows the open maintenance position and how containers 10 which mate with the bottom of the box can be removed for empting and reloading with litter 25 and closing of lids 26 if required. Note also hinge 45, on which the upper half of the litter box rests at an opening angle of 100 degrees, litter containment rim 43, handle 44 can be used to open and close the litter box, grille 42 clamping (when closed) containers 10 against base 41 concealing mouths 20 of containers.

The amount of litter needed in these containers for good medical samples vary from a few spoonfuls to a small cupful depending on cats' preferences. Inert litter materials like plastic beads, paraffin coated sand, rubber granules, aquarium gravel or non-absorbable long lasting litters etc are preferred if all the possible parameters are being tested. However, one may have a cat, which requires only pH, glucose or any other single parameter monitoring. A cat may like one of the following litters: clay, wheat, corncob, citrus, cedar wood, straw, peanut shell, orange peel, sand, potting mixture, coconut husk, pine, walnut shell or second hand paper pellet based litters etc. The cat's chosen litter can be saturated with water and pre-tested to find out if the litter itself affects the nominated test pad. If not, a sufficient amount of litter acceptable by the cat can be placed in each container making sure that when the container is visited there is enough unabsorbed urine left for the dipping of the test strip. In this instance the other possible false positive readings on the irrelevant pads can be ignored. Getting a meaningful veterinary urine sample from a cat can be difficult. Taking the cat to a veterinarian for catheterization or cystocentesis is not always the right solution either, as the very trip to the vet can course stress that may substantially alter the urine values like pH due to hyperventilation etc. Relaxed home atmosphere samples are preferred. As it is difficult to get a midstream urine sample from a cat, a total sample is generally accepted. Sometimes the dietary monitoring is performed for several days at a time. During the medical applications all the compartments of the litter box are loaded with clean containers including litter and sealed test strips. When the medical survey is finished the unused containers can be removed for later use with cats and the litter box converted to normal daily waste disposal mode, reusing containers. Alternatively the medically loaded containers can be emptied from litter and used for dogs or people as required. With this container, the daily amount of cat urine (or change in it) can be easily determined by subtracting the weight of the representative container prior to soiling from the weight of the soiled container. The method works well even when the litter has absorbed the urine completely and there is no liquid present.

This transparent disposable container can also be used with powder type color changing reagent pieces sensitive to urine pH or glucose etc as an alternative method for the test strips technique with cats. Relatively small amounts of those powders can be placed anywhere along the bottom grooves 11 of the container prior to loading it with a cupful of various litters including some clumping litters. The color changes can be observed through the transparent bottom of the container. The advantage of those color-changing pieces is that they can hold meaningful color information for long periods even days, whereas the moistened test strip looses its accurate colors sometimes after only 2 minutes. Another advantage is that these small disposable containers do not require cleaning and there is no need to mix a teaspoonful of powder into a cupful of litter. Conventional litter boxes have to be sanitized and dried before a packet-full of indicator pieces or powder can be completely blended into a heavy bucketful of litter using utensils, which in turn have to be stored and kept clean. Also these disposable transparent containers are convenient for accommodating special blood indicating litters required to be used in small quantities as an alternative indication method for the presence of blood in cat urine.

FIG. 13 illustrates how the container 10 is used with dogs. One container 10a (it can be pre-used, as sterility is not essential for this reusable cradle container) can be attached, as a holder or cradle, to any stick, lath or handle 46 with screwing, nailing, tacking, gluing etc at locations 47. The improvised handle 46 can be of any reasonable length, it may have a bend on it or it can be molded as a one-piece optional accessory. A clean disposable container 10 can then be nested in the cradle container 10a where it fits firmly. During the morning walk, a fresh disposable container with or without the above handle arrangement can be briefly inserted under the business end of the dog when he/she squats or lifts his/her leg and the midstream sample obtained with relative ease. The sample can be tested on the spot or alternatively, the lid can be snapped on and the sample brought home where it can be tested or it can be taken to the vet for a professional analysis or both.

FIG. 14 illustrates how women can use the containers for themselves or for others. Some women are frightened when they are requested to go to the toilet and return with a clean-catch midstream urine sample in a small cup. With this invention, they can place the disposable sanitary urine container 10 in the bottom of the toilet bowl 48 where it fits snugly without touching water 50, supported by the container's bottom corners without the upper rim touching the walls of the bowl. Now a human female can sit upright and start voiding. Without stopping the urine flow, she can lean forward 51 for a few seconds and then lean back 52 and complete the process. The clean-catch midstream sample 53 is captured in the container. The early and late flows 54 go over the container and will be drained into the toilet through gap 55 between the rectangular container and the oval shaped toilet bowl. The lid can be snapped on and the parcel passed to the nursing staff for analysis or ladies can collect the sample in the privacy of their home and perform the preliminary guidance-seeking test themselves. It is obvious that the container is not limited solely to female use, but is equally suitable for males while the container is placed in the toilet bowl or during hand-held application. Naturally, appropriate cleansing techniques are required before collection of urine samples, as bacterial contamination can confuse the clinical interpretation and cause invalid chemical results as well as microbiological findings.

It will be appreciated that the invention has been disclosed with reference to particular details of construction and this should be interpreted as examples and not as limitations to the scope or spirit of the invention.

1. A container for urine collection and testing, comprising:
a disposable plastic body, the body having a rim with a sealing lip and having affixed to an exterior surface, a sealed envelope containing a test strip.

2. The container of claim 1, wherein:
the body further comprises raised portions formed on a bottom of the container, the raised portions adapted to mate with cooperating features formed on the bottom of a cat box.

3. The container of claim 1, further comprising:
a lid which seals the container.

4. The container of claim 3, further comprising:
a pro-packaged charge of cat litter in the container.

5. The container of claim 1, further comprising:
a label affixed to an exterior surface, the label having printed on it information pertaining to the interpretation of the test strip.

6. The container of claim 1, wherein:
the body has sides which taper for nesting.

7. The container of claim 1, wherein:
the envelope is non-transparent.

8. The container of claim 1, wherein:
the test strip is a urine test strip.

9. The container of claim 2, wherein:
the raised portions are two in number.

10. The container of claim 2, wherein:
the raised portions are parallel mounds with tapered sides.

11. The container of claim 10, wherein:
the raised portions have flat tops.

12. A container for urine collection and testing, comprising:
a disposable plastic body with tapered sides, the body having a rim with a test strip; the body further comprising raised portions formed on a bottom of the
the body further comprising raised portions formed on a bottom of the formed on the bottom of a cat litter box; formed on the bottom of a cat litter box;
a label affixed to an exterior surface, the label having printed on it a lid which seals the container.
a lid which seals the container.

13. The container of claim 12, further comprising:
a pre-packaged charge of cat litter in the container.

14. The container of claim 2, wherein:
the cat litter box is a partitioned cat litter box.

15. The container of claim 1, wherein:
the body is transparent or translucent.
